(19) United States
(12) Patent Application Publication
(10) Pub. No.: US 2007/0282660 A1
(43) Pub. Date: Dec. 6, 2007

(54) Task management systems and methods

(76) Inventor: Peter Forth, Warrens (BB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/445,480

(22) Filed: Jun. 1, 2006

(51) Int. Cl. G06F 15/02

(52) U.S. Cl. 705/9

(57) ABSTRACT

Task management systems and methods are provided. A task can be assigned and delivered electronically to a person, an assignee, whom is responsible for completing the task without the person having to register or setup an account with any task management service. The assignee receives the task as an email with several embedded hyperlinks that allow the assignee to accept, decline edit or complete the task. Specific roles and permissions can be assigned to each e-mail associated with an assigned task. When the task event is created, each e-mail address referenced in the To line refers to an assignee, and each assignee has read/write access to the task. Each e-mail address referenced in the CC line of the task event only has read access to the task. Assignees can be reminded of their tasks. Tasks can be assigned to multiple recipients, which can be beneficial for team-based projects. In this way, users can assign tasks to more than one recipient such that each receives a copy that can be modified, tracked and completed independent of the other copies.

### BACKGROUND

The use of project collaboration and task management software and websites is becoming increasingly prevalent in the workplace. Existing software-based and web-based services allow users to assign tasks to other users of the service. These tasks can include details such as subject, start date, due date, status, priority, details and myriad other descriptive data.

An integral feature of these services is the capacity to make tasks available for review by others such as peers and managers. Many task management services allow users to share an entire folder of tasks such that it is visible to another user or group of users. In these systems, users who have access to the folder are able to see tasks assigned to other users. However, folder-based viewing of tasks is not flexible and these services limit users to assigning tasks only to a small group of users that are registered with the service.

Another important aspect of these services is the ability to arrange and organize tasks in a hierarchy. Some task management services contain task trees such that a parent task is created with a number of child tasks that are subparts of the parent. However, these systems typically rely on shared folders for users to view tasks that others have made. In such a system, each task will only have one parent within the tree and will only reside in one folder, the entire folder being visible to all users granted access to any task within it.

Finally, as computers become more central to business operations, it is important that tasks can be delivered to assignees by email. Task management services that provide this benefit send tasks as static text with the information provided by the assignor and possibly a hyperlink to the task on the service.

A ubiquitous example of an existing task assignment system is Microsoft Outlook. On the surface this program appears to allow users to assign a task to one or more arbitrary email addresses. However, closer inspection reveals that a task sent to a person whose email account is not hosted by the sender's Microsoft Exchange Server loses its form as a task and is reduced to an email message. Therefore, Outlook only allows users to assign tasks to a limited set of email addresses registered within the Microsoft Exchange Server. Similarly, Outlook only allows users to assign tasks to multiple recipients as email messages.

### SUMMARY OF THE INVENTION

In today's dynamic global environment, the critical nature of accuracy and efficiency in task management for a company's business operations can mean the difference between success and failure for a new product or even the company, itself. While users want a comprehensive and versatile task management solution, conventional task management systems often require users to register with the system. Other systems only provide access to static, limited task related information.

Ideally, task assignors should be able to assign a task to multiple recipients as team-based projects are heavily favored in the marketplace. Existing services, however, do not allow users to assign tasks to more than one recipient such that each receives a copy that can be modified, tracked and completed independent of the other copies.

The present invention relates to a versatile and comprehensive scheme for task management. Preferably, users of the present invention can receive tasks, without having to register or set up an account with the system. In this way, the present system is not dependent on a particular software environment. Rather, as long as users have access to an email client, a web browser, an instant messaging client or a telephone, users are able to accept, edit, modify and track tasks. Users are required to register or setup an account with the system to assign tasks to others who are not necessarily registered with the service.

A task management system and method can be provided in which a task is assigned to one or more assignees by specifying an identity designator for each assignee. The identity designator can be an email address, a screenname in an instant messaging client, or a telephone number. Each assignee's respective email addresses can be specified using a comma, semicolon, space or the like in between each email address. The assignees are responsible for completing the task. The assigned task is delivered to the assignees by e-mail, web browser, instant messaging client, or telephone. The assignees receive the assigned task without having to register with any task management system. Tasks can be assigned to multiple assignees such that one task is created to be shared by all assignees or an individual task is created for each assignee. Assignees can be copied in a task so that they are able to view the task, but are not required to complete it. Assignees can be copied in a task so that they are able to view the task, are not required to complete it, and all other assignees do not know the assignee was copied.

Preferably, the task is a request to complete an action, a poll, a yes/no question, a multiple choice question or a single edit box input. The task is created by the creator. The assigned task is a two-way flow of information in which the creator interactively monitors and modifies the assigned task after the assignees have received the assigned task. The creator can track the status of the assigned task. The creator receives an alert when the assigned task has been completed. The creator can send a reminder to an assignee to complete the task. If an assignee is to receive a plurality of reminders for a plurality of independent tasks, a single reminder containing all those tasks is sent.

The assigned task, which is received by the assignees, includes an embedded hyperlink in the email message. The hyperlink enables the assignees to complete the assigned task, edit the assigned task, accept the assigned task, or decline the assigned task. Permissions associated with the task can be specified for each assignee.

The task management systems and methods can be integrated with an instant messaging client. The task management systems and methods can be integrated with a telephone/cellphone.

According to another aspect of the invention, a software system for managing tasks is provided. A task management engine can assign a task to one or more assignees by specifying an identity designator for each assignee. A task handler can accept task data from a task creator and delivering the assigned task to one of the assignees. The task can be received by the assignee without the assignee having to register with any task management system.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a screenshot illustrating a task creation window according to an embodiment of the present invention.

FIG. 2 is a screenshot illustrating a list of organizational folders according to an embodiment of the present invention.

FIG. 3 is a flow diagram describing the creation of separate tasks for independent users and the attributes assigned to each task.

FIG. 4 is a screenshot illustrating a user's outbox showing separate tasks created and assigned to independent Assignees and actions that can be taken with said tasks.

FIG. 5 is a flow diagram describing the assignment of tasks to a user via email with embedded hyperlinks.

FIG. 6 is a diagram illustrating the tables in a task database used for handling assignments in a task hierarchy.

FIG. 7a is a diagram illustrating a task hierarchy.

FIG. 7b is a diagram illustrating an example of the data stored in the TaskToPosition table in a database used for handling assignments in a task hierarchy.

FIG. 8 is a screenshot illustrating the integration of a multiple choice decision assigned to multiple Assignees into a task display window, each having a separate status and answer.

FIG. 9 is a screenshot illustrating integration of a task creation system with an instant messenger application according to an embodiment of the present invention.

FIG. 10 is a screenshot illustrating a menu in an instant messenger application for creating a task.

FIG. 11 is a screenshot illustrating a menu in an instant messenger application for initiating a pop-up request for a status update on a task, reassigning a task, deleting a task and editing or modifying a task.

FIG. 12 is a screenshot illustrating a task creation window in an instant messenger application according to an embodiment of the present invention.

FIG. 13a is a flow diagram describing an embodiment of the integration of an instant messenger application with the task management system via an XML API.

FIG. 13b is a flow diagram describing an embodiment of the integration of an instant messenger application with the task management system via an XML API.

FIG. 14 is a flow diagram describing the assignment of tasks to a user via a voice or touch-tone interface.

FIG. 15 is a flow diagram describing the receipt of tasks via a voice or touch-tone interface.

### DETAILED DESCRIPTION OF THE INVENTION

A description of preferred embodiments of the invention follows.

The present invention generally relates to a revolutionary task management system that allows users to send tasks to others through easy and intuitive user interfaces as easily as they can send emails.

A task is a request from one person to another to complete an action. The Creator is the person who creates and sends the task. The Assignee is the person to whom the task is delivered and who is responsible for completing the task. A task, however, should be more than a one-way request. Preferably, each task involves a two-way flow of information in which the Creator can interactively monitor and modify the task that it has sent after the Assignee has received it. This allows the Creator to track the status of the task and know when it has been completed. Without this two-way flow of information, a task request is no different than a static email message in which the Creator asks the recipient to do something.

### I. Use of Email to Deliver and Complete Tasks by Both Registered and Unregistered Assignees.

According to an aspect of the invention, unlike other task management services, it is not necessary to register and create an account to use the invention. This is a powerful feature because it means that a Creator can send tasks to Assignees both inside and outside the Creator's organization. An Assignee who is not registered with the service will receive assigned tasks as an email with several embedded hyperlinks that open web pages on the system allowing the Assignee to accept, decline, edit or complete the task.

### II. Use of Email Addresses to Send Tasks.

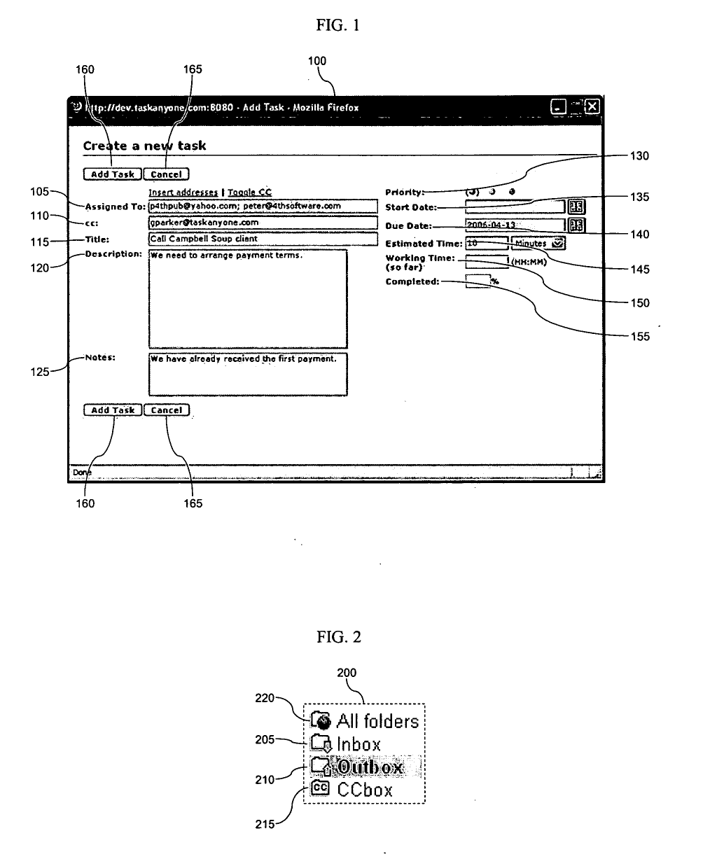

In an example embodiment of the present invention, Creators assign tasks using Assignees' email addresses. In fact, creating a task with the service is similar to sending an email from a web-based email client where the send specifies information such as To, CC, BCC, Subject Title, and Body. FIG. 1 is a screenshot illustrating a task creation window 100 according to an embodiment of the present invention. As shown in FIG. 1, to create a task a Creator specifies information such as Assigned To 105, CC 110, Title 115, Description 120, Notes 125, Priority 130, Start Date 135, Due Date 140, Estimated Time 145, Working Time (so far) 150, and Completed 155.

### III. Organizational Folders for Tasks.

FIG. 2 is a screenshot illustrating a list of organizational folders according to an example embodiment of the present invention. As depicted by FIG. 2, users are able to view a list of folders 200. Each Assignee to whom tasks have been sent has a folder on the system called Inbox 205 into which new tasks that have been assigned to that Assignee are stored. Further, each registered user that has an account on the system has a folder on the system called Outbox 210 into which all outgoing tasks that the user has created and assigned to other users are available for monitoring. Additionally, each user has a special folder on the system called CCbox 215 into which tasks that the user has been CC-ed on, but does not need to actually complete, are stored so that the tasks may be monitored. Finally, users have the ability to view the content of All Folders 220 simultaneously, thereby displaying the content of the user's Inbox 205, Outbox 210 and CCbox 215 in one list.

### IV. Sending a Task to Multiple Recipients.

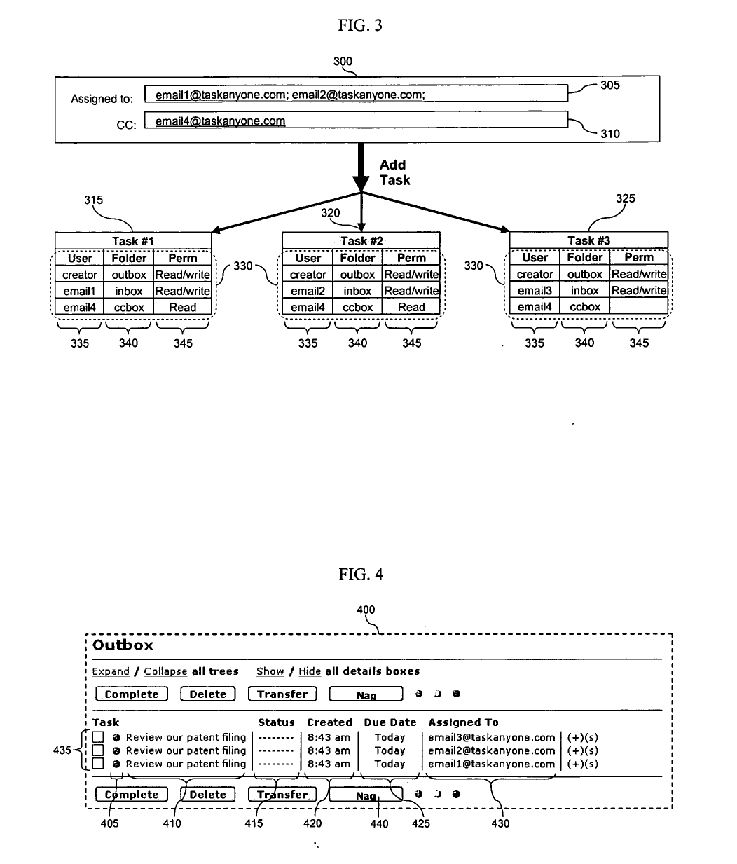

One aspect of the invention that is not generally possible in other task management services is the ability of a Creator to send tasks to more than one Assignee such that an independent task is created for, and is delivered to, each Assignee. FIG. 3 is a flow diagram describing the creation of separate tasks for independent users and the attributes assigned to each task. As shown in FIG. 3, multiple tasks can be created from the data fields 300, such as Assigned To 305 and CC 310 as depicted here. When a Creator enters more than one email address into the Assigned To 305 data field a separate task is created for each email address. Thus, Task #1 315 is the task created for email1@taskanyone.com, Task #2 320 is the task created for email2@taskanyone.com, and Task #3 325 is the task created for email3@taskanyone.com.

When these tasks are created they are assigned certain attributes 330. Thus, in this example, each task has a total of three users 335 associated with it: a Creator (the user that created the task), the Assignee (either email1@taskanyone.com, email2@taskanyone.com or email3@taskanyone.com) and a CC recipient (email4@taskanyone.com). Each user, because of its unique role in the task, has the task delivered to a different folder 340. Creator has its copy of the task delivered to its Outbox. Each Assignee (either emailltaskanyone.com, email2@taskanyone.com or email3@taskanyone.com) has its copy of the task delivered to its Inbox. The CC recipient has its copy delivered to its CCbox.

Additionally, because of these roles, each user is assigned different permissions 345 to access the task. The Creator is granted both read and write access so that it may view and edit the tasks which it has assigned. Assignees are granted both read and write access so that they may view the tasks they have been assigned, assign the tasks to other users, or edit any task data. CC recipients are only granted read access so that they may see all elements of tasks and monitor tasks dynamically for changes.

Optionally, when a Creator enters more than one email address into the Assigned To 315 data field, the Creator can create a single task assigned to each of the Assignees in common and each Assignee is granted both read and write access to have the ability to view and modify the task.

FIG. 4 illustrates the result of the action performed in FIG. 3 in which multiple Assignee email addresses entered into the Assigned To field results in a separate task being created for each email address.

### V. Reviewing Tasks and Nagging Assignees

A user can review tasks it has created and assigned. FIG. 4 is a screenshot illustrating a user's Outbox showing separate tasks created and assigned to independent Assignees. A user's Outbox 400 retains copies of each task that was created or assigned by that user. In addition, the Outbox 400 displays the following information about each task: Priority 405, Title 410, Status 415, When It Was Created 420, Due Date 425 and To Whom It Was Assigned 430.

In addition to reviewing tasks that a Creator has assigned, a Creator can send a nag to the Assignee of a task as a reminder to complete the task. First, the creator clicks the selection box 435 associated with the Assignee 430 assigned to a particular task 410 that it wants to send a nag for. The Creator can then click the nag button 440 to send the nag to the Assignee.

Using this same procedure of clicking the selection box 435 and then the nag button 440, a Creator can send multiple nags at one time. For example, in FIG. 4, if the Creator clicked all three selection boxes 435 and then clicked the nag button 440, individual nags would be sent to the three Assignees, email1@taskanyone.com, email2@taskanyone.com and email3@taskanyone.com. Further, if the Creator clicks selection boxes 435 associated with a plurality of tasks that are associated with one Assignee and clicks the nag button 440, that one Assignee will receive the plurality of nags in one condensed message rather than a plurality of nag messages.

### VI. Delivering Tasks by Email.

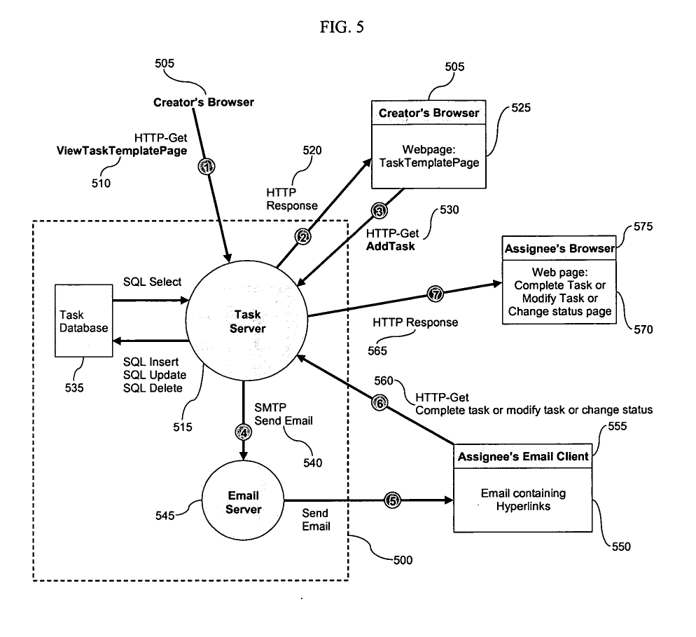

FIG. 5 describes the assignment of tasks by a Creator to an Assignee via email with embedded hyperlinks through a Task Management System 500. A Creator's Browser 505 sends an HTTP-Get request, ViewTaskTemplatePage, 510 to the Task Server 515. In an HTTP response 520, the Task Server 515 sends a Webpage, TaskTemplatePage, 525 to the Creator's Browser 505. After filling in the task data fields and selecting a command, the Creator's Browser 505 sends an HTTP-Get request, AddTask, 530 to the Task Server 515. The Task Server 515 then communicates with the Task Database 535 to update the task data. The Task Server 515 sends a SMTP command, Send Email, 540 to the Email Server 545. The Email Server 545 then sends an Email containing hyperlinks 550 to the Assignee. The Assignee's Email Client 555 then retrieves the Email message containing hyperlinks 550. The Assignee then clicks on a hyperlink to complete, modify or change the status of the task causing the Assignee's Email Client 555 to send the respective HTTP-Get request 560 to the Task Server 515. The Task Server 515, in an HTTP response 565, delivers a Webpage 570 to the Assignee's Browser 575 displaying the respective page requested by the hyperlink in the Email containing hyperlinks 550.

### VII. Handling Assignments in a Task Hierarchy.

The system allows hierarchies of tasks to be constructed, with parent tasks and child tasks related to one another in a tree format. Assigning and CC-ing different tasks within task trees to different recipients in which not all recipients involved can see the tasks that other recipients are working on requires special treatment and has not been solved before.

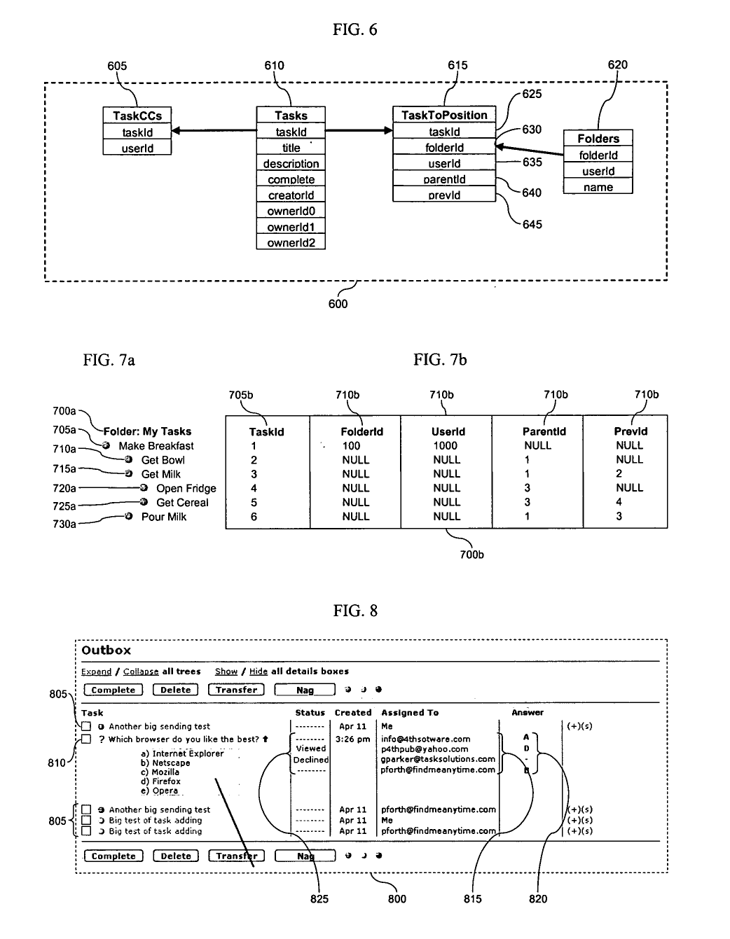

FIG. 6 is a diagram illustrating the tables in a task database used for handling assignments in a task hierarchy. As shown in FIG. 6, the task hierarchy is depicted as a Task Database 600. Each record in the TaskToPosition table 615 associates a unique taskId 625 for each task with a folderId 630 for each folder, userId 635 for each user and parentId 640 for each parent task. The prevId 645 value for the previous task allows for further hierarchy detail such that a taskId 625 may be specified for each task indicating what tasks in that particular level of the hierarchy must be completed before the present task. If there is no task that must be completed first, the prevId value 645 may be set to NULL. Each task has its own TaskToPosition records, such as taskId 625, folderId 630, userId 635, parentId 640, and prevId 645, for each different tree that it appears in for different users.

This hierarchy is best explained through the use of an example provided by FIGS. 7a and 7b. FIG. 7b is a diagram illustrating an example of the data stored in the TaskToPosition table in a database used for handling assignments in a task hierarchy. Within the TaskToPosition table 700b there are the following data columns: TaskId 705b, FolderId 710b, UserId 715b, ParentId 720b and PrevId 725b. FIG. 7a is a diagram illustrating a task hierarchy in a tree form. Read together in line with FIG. 7b, the nature of the data columns in the TaskToPosition table 700b becomes evident.
Parent task Make Breakfast 705a is given TaskId 705b 1, FolderId 710b 100 (corresponding to Folder My Tasks 700a), UserId 715b 1000 (corresponding to the current user), ParentId 720b NULL (parent tasks do not have any tasks higher in the task hierarchy) and PrevId 725b NULL (parent tasks do not have any tasks that must be completed before them). Parent task Make Breakfast 705a has three child tasks: Get Bowl 710a, Get Milk 715a and Pour Milk 730a.
   Child task Get Bowl 710a is given TaskId 705b 2, FolderId 710b NULL (child tasks are not placed in a folder as they are a subpart of the parent task), UserId 715b NULL (a task's associated user is an attribute inheritable from the parent task), ParentId 725b 1 (corresponding to TaskId 705b 1, child task Get Bowl's 710a parent task) and PrevId 725b NULL (child task Get Bowl 710a is the first child task of parent task Make Breakfast 705a and therefore there are no tasks to be completed first).
   Child task Get Milk 715a is given TaskId 705b 3, FolderId 710b NULL (child tasks are not placed in a folder as they are a subpart of the parent task), UserId 715b NULL (a task's associated user is an attribute inheritable from the parent task), ParentId 725b 1 (corresponding to TaskId 705b 1, child task Get Milk's 715a parent task) and PrevId 725b 2 (corresponding to TaskId 705b 2, the task (Get Bowl 710a) that must be completed before the current task (Get Milk 715a)). Child task Get Milk 715a has two child tasks: Open Fridge 720a and Get Cereal 725a. These tasks 720a and 725a are grandchildren to parent task Make Breakfast 705a.
      Child task Open Fridge 720a is given TaskId 705b 4, FolderId 710b NULL (child tasks are not placed in a folder as they are a subpart of the parent task), UserId 715b NULL (a task's associated user is an attribute inheritable from the parent task), ParentId 725b 3 (corresponding to TaskId 705b 3, child task Open Fridge's 720a parent task) and PrevId 725b NULL (child task Open Fridge 720a is the first child task of parent task Get Milk 715a and therefore there are no tasks to be completed first).
      Child task Get Cereal 725a is given TaskId 705b 5, FolderId 710b NULL (child tasks are not placed in a folder as they are a subpart of the parent task), UserId 715b NULL (a task's associated user is an attribute inheritable from the parent task), ParentId 725b 3 (corresponding to TaskId 705b 3, child task Get Cereal's 720a parent task) and PrevId 725b 4 (corresponding to TaskId 705b 4, the task (Open Fridge 720a) that must be completed before the current task (Get Cereal 725a)).
   Child task Pour Milk 730a is given TaskId 705b 6, FolderId 710b NULL (child tasks are not placed in a folder as they are a subpart of the parent task), UserId 715b NULL (a task's associated user is an attribute inheritable from the parent task), ParentId 725b 1 (corresponding to TaskId 705b 1, child task Pour Milk's 730a parent task) and PrevId 725b 3 (corresponding to TaskId 705b 3, the task (Get Milk 715a) that must be completed before the current task (Pour Milk 730a)).

The five data columns in TaskToPosition table 700b (TaskId 705b, FolderId 710b, UserId 715b, ParentId 720b and PrevId 725b) govern the following rules that create the service's hierarchy.
A child task that is assigned to a recipient who has not been assigned or CC-ed on the parent task is put in the recipient's inbox and the recipient is not able to view the rest of the task tree that the child task's parent is a part of. The task is effectively placed in two task trees: the original tree and a tree by itself in the Assignee's inbox.
Once a task is in a recipient's inbox the recipient can reposition that task to any point in any other task tree that the recipient has write access to.
Through a combination of assigning a child task to another recipient and the Assignee moving that task into one of the Assignee's own task trees, each task can effectively have multiple parent tasks.
Child tasks can inherit attributes such as completion, start date, due date and status from their parent tasks such that if a child task is incomplete then all its parent tasks must be incomplete, a child task's due date must be less than or equal to the earliest due date of any of its parent tasks, a child task's start date must be greater than or equal to the earliest start date of any of its parent tasks, and if for some reason a parent task has a child task that becomes out of synch with its parental restrictions, a graphical flag can be displayed to warn a user of the condition.
If a Creator assigns a child task to an Assignee who has already been assigned or CC-ed on the parent task, then the child task will appear underneath the parent task for both the Creator and the Assignee. Because the Assignee is able to see the child task under the parent task, it is not necessary to create a separate task tree for it in the recipient's inbox. Therefore, the child task has only a single position in one shared task tree rather than two positions within two different task trees.
If a Creator assigns a child task to a recipient and that recipient has been assigned or CC-ed on the parent task, there is no inbox entry made for the recipient. If at a later date the Assignee is no longer assigned to or CC-ed on the parent but is still assigned to the child then the system will recognize when this event occurs and will add the child task to the recipient's inbox at that time.
A recipient is always able to see all the child tasks of any task assigned or CC-ed to that recipient. This holds true even if the child tasks are not assigned or CC-ed to the recipient.
A recipient is not necessarily able to edit child tasks of a parent task that is assigned to that recipient. The recipient must be the Creator of a task or the task must be assigned to the recipient in order to edit it. Otherwise, a recipient could drag a read only task that the recipient has been CC-ed underneath a task that the recipient owns in order to illegitimately given the recipient the ability to edit it.
If a task the recipient owns has child tasks that the recipient does not own, the Assignee may be prevented from doing things like completing the parent task if the child task is incomplete, changing the due date to before the due date of the child task, and changing the start date to after the start date of the child task. Because an Assignee cannot edit the child task but should retain full control of the parent task to overcome these restrictions the Assignee is able to delete the child task.
When an Assignee deletes a task that the Assignee has read-only access to, it does not delete the task itself but rather just removes it from the task tree. If other recipients were viewing that task as a part of the Assignee's task tree they must still be able to access the task so it is repositioned to their respective inbox or CCbox.

### VIII. Polling and Authorizations.

In addition to sending and tracking tasks, preferably, the invention sends and tracks other types of interactive requests such as yes/no decisions, multiple choice questions and single edit box inputs. For example, if the approval of two managers was required to authorize an expense a decision, it could be created and referenced as, “Do you authorize this expense?” In this example, both managers' email addresses are entered into the Assigned To box and the request is sent.

The system preferably allows users to send requests for yes/no answers, multiple choice answers and text-based answers to questions. The distribution, assignment and sharing of decisions and authorizations are preferably handled in an identical manner to how tasks are handled and are unique for all the same reasons the task distribution system is unique, including, but not limited to: multiple decisions are generated from a single form with multiple Assignees, the ability to CC recipients, the ability to send decisions to any email address, embedded tracking graphics, instant messenger integration and telephone/touch tone integration.

The Creator of the tasks is able to see the responses of all the Assignees that he assigned a multiple request to on a single webpage or instant messenger screen such as that illustrated by FIG. 8. FIG. 8 is a screenshot illustrating the integration of a multiple choice decision assigned to multiple Assignees into a task display window, each having a separate status and answer. Within Outbox 800 are a number of tasks 805 with varying levels of priority and a question 810 posed to multiple Assignee 815. A column in the Outbox 800 indicates the Assignees' 815 replies 820. Another column indicates the statues of the question 825.

To implement this function most of the structures and coding required to send and manage tasks is reused. However, a Type flag is added to distinguish the type of request (task, yes/no decision, multiple choice decision, text response) and an Answer field to store responses. For multiple choice decisions, the various choices could be parsed out of one of the existing free form text fields used by tasks such as Notes Other task elements such as title, description, due date, status and priority can all be used within the decision and authorization context.

### IX. The Interfaces.

### A. Web Interface.

One example embodiment of the present invention provides an interface that uses a web browser for creating and maintaining tasks. FIG. 1 is a screenshot illustrating a task creation window according to an example embodiment of the present invention. The browser window 100 is for illustrative purposes only and the actual look and feel of the window 100 may take many forms.

### 1) Data Fields.

The browser window 100 contains data fields to be completed by the Creator and descriptive text strings assigned to each data field. Data field Assigned To 105 contains a list of one or more email addresses separated by a comma, semicolon, space or the like, similar to how a user would send an email to one or more recipients using an email client. Data field CC 110 contains a list of one or more email addresses separated by a comma, semicolon, space or the like, similar to how a user would CC an email to one or more people. Data field Title 115 contains the title of the task. Data field Description 120 contains a more detailed explanation of the task. Data field Notes 125 contains additional information pertinent to the task. Data field Priority 130 allows the Creator to select a desired level of importance for the task. Data field Start Date 135 contains the date when the Creator desires the Assignee to begin performing the task. Data field Due Date 140 contains the date by when the Creator desires the Assignee to complete performance of the task. Data field Estimated Time 145 contains the amount of time that the Creator believes is appropriate for completing the task. Data field Working Time (so far) 150 contains the amount of time the Assignee has cumulatively worked on the task. Data field Completed 155 contains a numerical value representing the percentage that the task is complete.

### 2) Buttons.

Further, the browser window 100 contains command buttons to be executed by the Creator. The Add Task button 160 creates a task using the data entered into data fields 105-155 by the Creator. The Cancel button 165 aborts the creation of a task and discards all data entered into data fields 105-155 by the Creator.

### B. Integration of Task Management and Instant Messaging.

In addition to the web-based interface, an example embodiment of the invention supports an XML API interface that allows downloadable third-party applications, such as instant messaging clients, to use the service, where the input is given to the service using HTTP-Get parameters. The accessible functions would include basic commands such as: get a list of tasks sent by a particular user, send a new task, modify a task, update a task's status, delete a task and complete a task. The Instant messaging client would need to be updated by its author in order to access the task management XML API on regular intervals to update views of tasks and to call the API when the user-initiated actions that would modify or interact with a task from the program's menus.

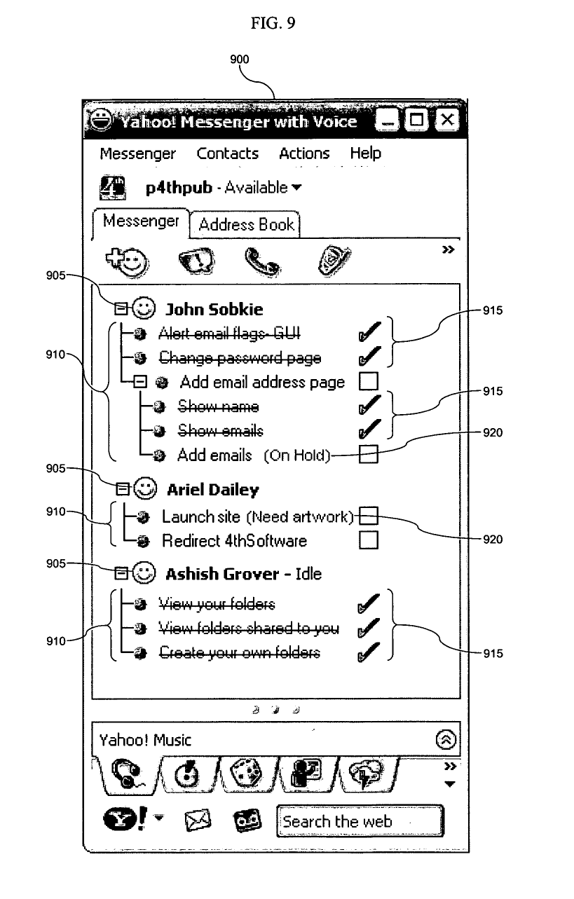

FIG. 9 is a screenshot illustrating integration of a task creation system with an instant messenger client application 900 according to an example embodiment of the present invention. The instant messaging client 900 is for illustrative purposes only and the actual look and feel of the instant messaging client 900 may take many forms. Through the XML interface, a an instant messaging client user is able to see all tasks 910 that have been sent to a particular user 905 either underneath the user name 905 in the instant messaging client as shown in FIG. 9 or in a secondary popup window (not depicted) that is accessed from the menu that appears when the user clicks on a user name 905. Further, a user is able to view the status of tasks sent to another user 905 within the instant messaging client. For example, the XML interface immediately reveals completed tasks 915 because they are crossed out and marked with a checkmark. Additionally, a user can define a status 920 of the task that is displayed in parenthesis next to the task name.

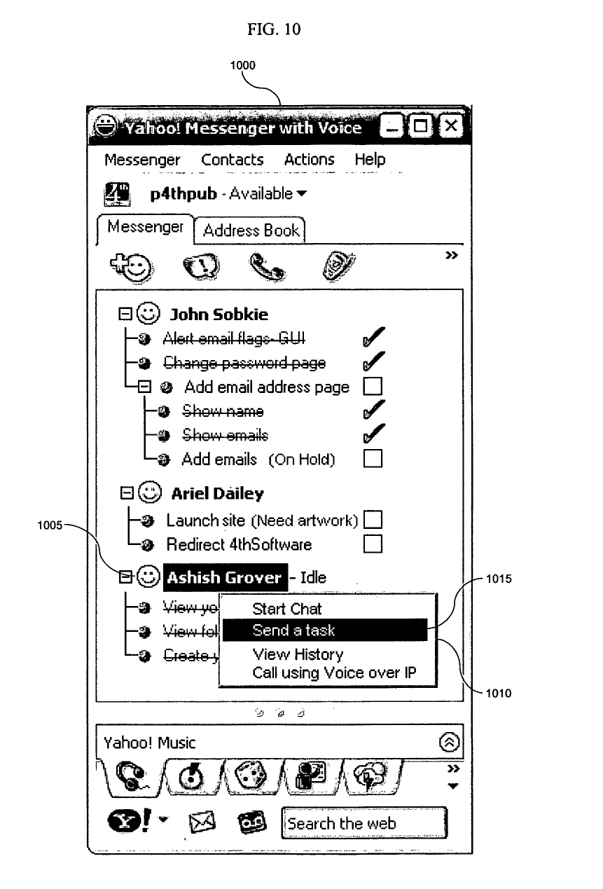

FIG. 10 is a screenshot illustrating a menu in an instant messenger application for creating a task in an example embodiment of the present invention. The instant messaging client 1000 is for illustrative purposes only and the actual look and feel of the instant messaging client 1000 may take many forms. The XML interface to the instant messaging client 1000 allows a user to send tasks to another instant messaging client user 1005 by selecting that user and opening a user-specific menu 1010 to call a popup dialog box by selecting the appropriate menu command 1015.

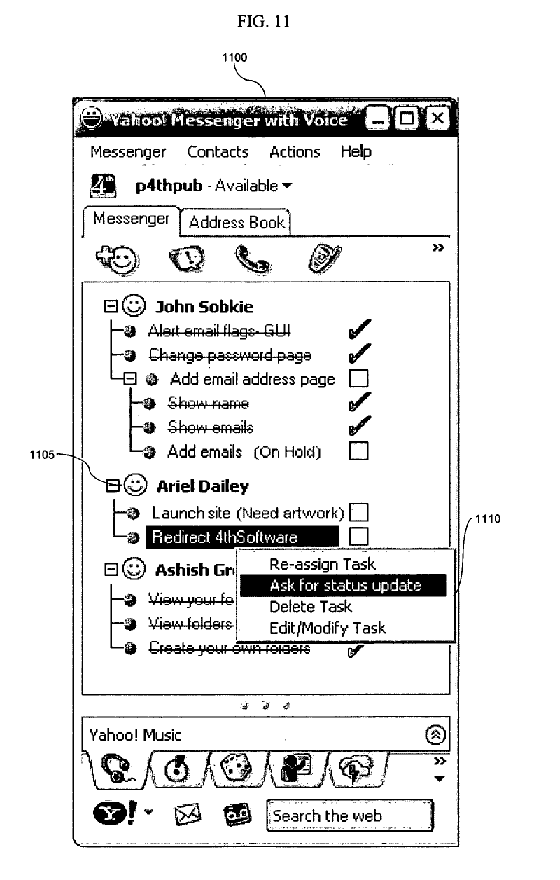

FIG. 11 is a screenshot illustrating a menu in an instant messenger client application 1100 for initiating a pop-up request for a status update on a task, reassigning a task, deleting a task and editing or modifying a task according to an example embodiment of the present invention. The instant messaging client 1100 is for illustrative purposes only and the actual look and feel of the instant messaging client 1100 may take many forms. The XML interface to the instant messaging client 1100 allows a user to request a task status update from another instant messaging client user by selecting that user and opening a task-specific menu 1110.

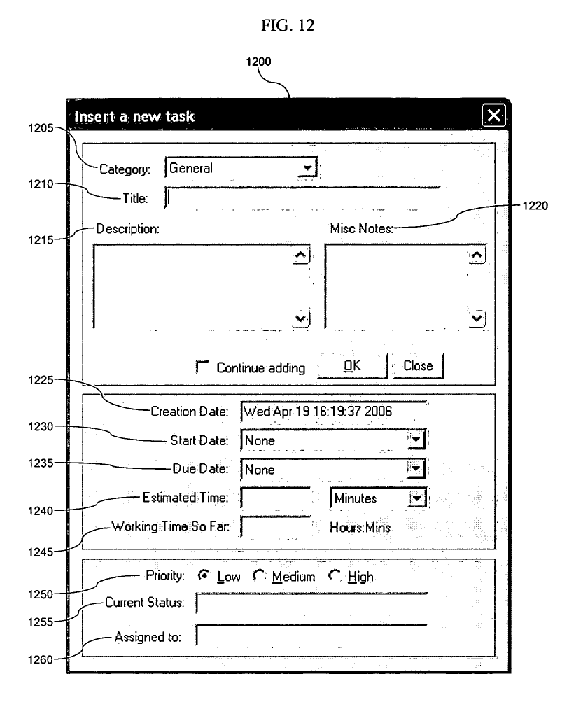

FIG. 12 is a screenshot illustrating a task creation popup dialog box 1200 in an instant messenger client application according to an example embodiment of the present invention. The task creation popup dialog box 1200 contains data fields 1205-1260 to receive the task data. Data field Category 1205 allows the user to select the type of task to create. Data field Title 1210 contains the title of the task. Data field Description 1215 contains a more detailed explanation of the task. Data field Misc Notes 1220 contains additional information pertinent to the task. Data field Start Date 1230 contains the date when the Creator desires the Assignee to begin performing the task. Data field Due Date 1235 contains the date by when the Creator desires the Assignee to complete performance of the task. Data field Estimated Time 1240 contains the amount of time that the Creator believes is appropriate for completing the task. Data field Working Time So Far 1245 contains the amount of time the Assignee has cumulatively worked on the task. Data field Priority 1250 allows the Creator to select a desired level of importance for the task. Data field Current Status 1255 contains a text string describing the status of the task. Data field Assigned To 1260 contains a list of one or more email addresses separated by a comma, semicolon, space or the like, similar to how a user would send an email to one or more recipients using an email client.

This XML interface will also allow the service to take advantage of other aspects of the instant messaging client such as the ability to pop up a notification on a user's desktop when that user receives a new task from an assignor, the ability to pop up requests for status updates from the task's assignor, the ability to pop up a notification on a Creator's or assignor's desktop when an Assignee completes a task, and the ability to pop up reminders at regular intervals when tasks assigned to that user are due or past due.

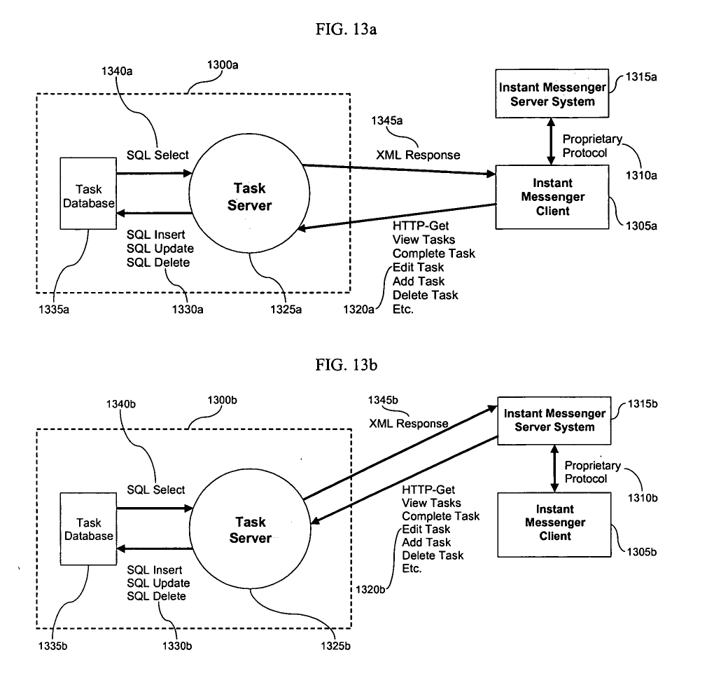

FIG. 13a is a flow diagram describing the integration of an example embodiment of the present invention with an instant messenger client application via an XML API. In particular, FIG. 13a describes an aspect of the invention concerning the integration of an Instant Messenger Client 1305a with the task management service 1300a via XML API. The Instant Messenger Client 1305a uses a proprietary protocol 1310a to communicate with the Instant Messenger Server System 1315a. The Instant Messenger Client 905a, sends HTTP-Get requests 1320a to the Task Server 1325a. The Task Server 1325a then communicates through SQL commands 1330a with the Task Database 1335a to perform the requested function. The result of this function is then sent from the Task Database 1335a via SQL Select 1340a to the Task Server 1325a. The Task Server 1325a then sends an XML response 1345a to the Instant Messenger Client 1305a.

FIG. 13b is a flow diagram describing an the integration of an example embodiment of the present invention with an instant messenger client application via an XML API. In particular, FIG. 13b describes a similar aspect of the invention concerning the integration of an Instant Messenger Server System 1315b with the task management service 1300b via XML API. The Instant Messenger Client 1305b uses a proprietary protocol 1310b to communicate with the Instant Messenger Server System 1315b. The Instant Messenger Server System 1315b sends HTTP-Get requests 1320b to the Task Server 1325b. The Task Server 1325b then communicates through SQL commands 1330b with the Task Database 1335b to perform the requested function. The result of this function is then sent from the Task Database 1335b via SQL Select 1340b to the Task Server 1325b. The Task Server 1325b then sends an XML response 1345b to the Instant Messenger Server System 1315b.

### C. Integration with Telephone/Touch Tone Automation.

In another example embodiment of the invention, in addition to sending and receiving tasks and requests for answers via emails, web pages and instant messages, is the use of assigning these items and gathering responses over the telephone.

### 1) Sending Tasks and Requests and Gathering Responses.

If a request is assigned to a telephone or cellphone number, then an automated system can dial that number and a computerized text reader can ask the Assignee a question or notify the Assignee that it has been assigned a task. When the Assignee is read a question it is able to respond to yes/no or multiple choice questions using the telephone keypad. When an Assignee is reminded that a task is due it is able to indicate that the task is completed using the telephone keypad.

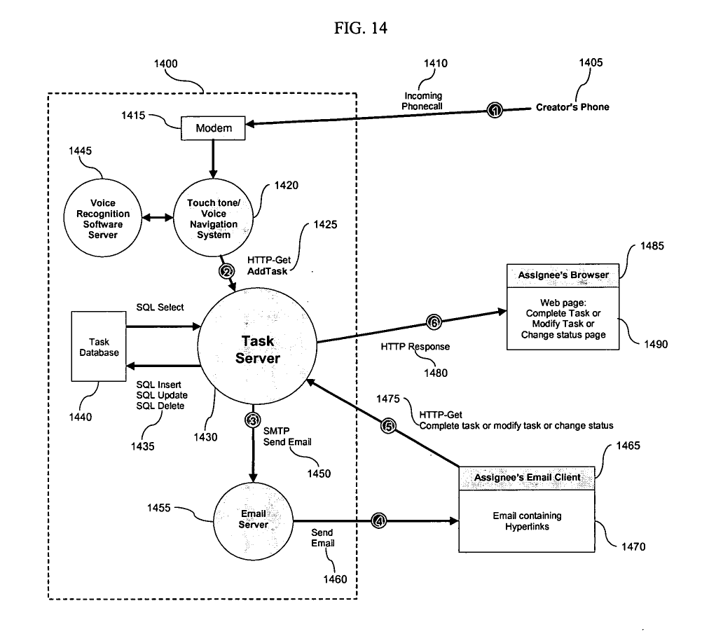

FIG. 14 is a flow diagram describing an example embodiment of the present invention whereby a Creator assigns tasks to an Assignee via a voice or touch-tone interface. In particular, FIG. 14 describes the interaction between the Task Management System 1400 and the Creator's Phone 1405 for assigning tasks to an Assignee via a Touch tonenoice Navigation System 1420. The Creator places a telephone call 1410 from Creator's Phone 1405 to the Modem 1415. After establishing the connection, the Touch tonenoice Navigation System 1420 sends an HTTP-Get request 1425, AddTask, to the Task Server 1430. The Task Server 1430 then communicates through SQL commands 1435 with the Task Database 1440 to prompt the Creator through Creator's Phone 1405, with the assistance of the Touch tone/Voice Navigation System 1420, for values for the data fields required to create a new task. When the Creator states a reply through the Creator's Phone 1405, the Touch tone/Voice Navigation System 1420 passes it to the Voice Recognition Software Server 1445 to be processed into a text value, which is then passed back to the Touch tone/Voice Navigation System 1420, to the Task Server 1430 and to the Task Database 1440. After all data field are filled for the creation of a new task, the Task Server 1430 uses the SMTP protocol 1450 to prompt the Email Server 1455 to send an email message 1460 to the Assignee. The Assignee then uses the Assignee's Email Client 1465 to retrieve the email message 1460 and click on the complete task, modify task or change status hyperlinks contained with the Email containing Hyperlinks 1470. The Assignee's Email Client 1465 then sends an HTTP-Get request 1470 to the Task Server 1430. The Task Server 1425 then sends an HTTP Response 1475 to the Assignee's Browser 1485 containing a webpage 1490 to complete the task, modify the task or change its status.

### 2) Receiving New Requests and Tasks.

In another example embodiment of the present invention, an automated voice recognition/touch-tone system can allow Creators to call in, specify content for fields such as assigned to, task title, due date, etc., and create new tasks or requests for answers. Optionally, task titles and descriptions are stored as audio clips rather than text.

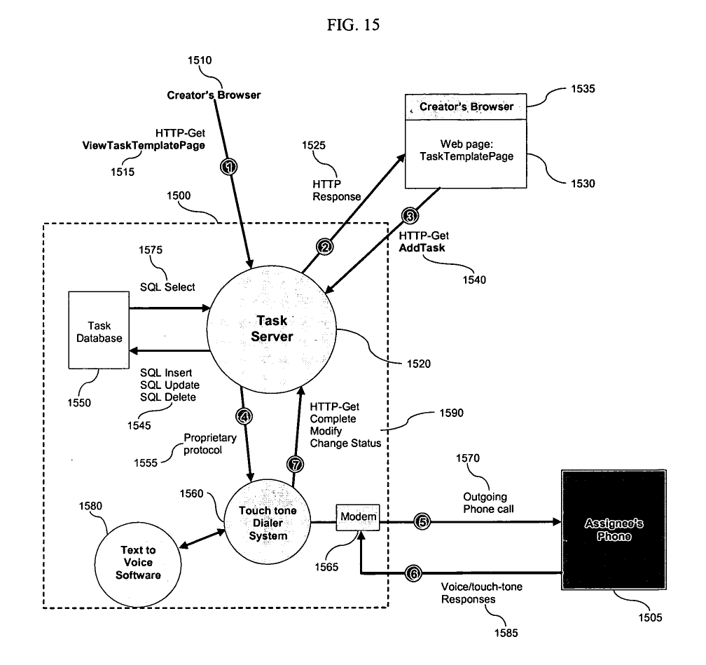

FIG. 15 is a flow diagram describing an example embodiment of the present invention whereby a user receives tasks via a voice or touch-tone interface. In particular, FIG. 15 describes the interaction between the Task Management System 1500 and the Assignee's Phone 1505 for receiving tasks via Text to Voice Software 1520. A Creator's Browser 1510 sends an HTTP-Get request 1515, ViewTaskTemplatePage, to the Task Server 1520. In response, the Task Server 1520 sends a HTTP response 1525, a Webpage 1530, TaskTemplatePage, to the Creator's Browser 1535. After filling in the task data fields and selecting a command, the Creator's Browser 1535 sends an HTTP-Get request 1540, AddTask, to the Task Server 1520. The Task Server 1520 then communicates through SQL commands 1545 with the Task Database 1550 to insert the task data. The Task Server 1520 then uses a proprietary protocol 1555 to communicate with the Touch tone Dialer system 1560 which uses a Modem 1565 to place an outgoing phone call 1570 to the Assignee's Phone 1505. The Task Server 1520 then retrieves text data via SQL Select 1575 from the Task Database 1520 and parses it through the Text to Voice Software 1580 via Touch tone Dialer system 1560 so that the text is converted to audible speech. This audio is then passed to the Modem 1565 and convert to a telephone signal to be sent to the Assignee's phone 1505. The Assignee can use the keys of the Assignee's phone or the Assignee's voice to give Voice/touch-tone Response 1585 which are received by the Modem 1565 and passed through the Touch tone Dialer system 1560 to the Task Server 1520 as HTTP-Get requests 1590 to complete, modify or change the status of a task. That data is then passed from the Task Server 1520 to the Task Database 1550 via SQL commands 1545.

It is also possible to combine the two preceding systems in order to both assign and receive tasks via the voice/touch-tone system.

While this invention has been particularly shown and described with references to preferred embodiments thereof, it will be understood by those skilled in the art that various changes in form and details may be made therein without departing from the scope of the invention encompassed by the appended claims. For example, it should be understood to those skilled in the art that aspects of the task management system could implemented in computer software or hardware. It should be further understood to those skilled in the art that a software implementation may be written in any number of software level languages (e.g. C++, C#, Perl, Java). Preferably, the software implementation would be able to handle incoming HTTP requests and communicate with a backend database in which the tasks and their positioning within various lists are stored.

What is claimed is:

1. A computer-implemented method for managing tasks comprising:
assigning a task to one or more assignees by specifying an identity designator for each assignee; and
delivering the assigned task to one of the assignees, where the task is received by the assignee without the assignee having to register with any task management system.

2. A computer-implemented method according to claim 1 wherein the assigned task is a request created by a creator to complete an action, a poll, a yes/no question, a multiple choice question or a single edit box input.

3. A computer-implemented method according to claim 2 wherein the assigned task further includes providing a two-way flow of information in which the creator interactively monitors and modifies the assigned task after the assignee has received the assigned task.

4. A computer-implemented method according to claim 3 further including:
enabling the creator to track the status of the assigned task; and
alerting the creator when the assigned task has been completed.

5. A computer-implemented method according to claim 1 wherein the task creator sends a reminder to one or more task assignees to complete the task.

6. A computer-implemented method according to claim 5 wherein an assignee receiving a plurality of reminders for a plurality of independent tasks receives a single reminder containing all selected tasks.

7. A computer-implemented method according to claim 1 wherein delivering the assigned task to one of the assignees further includes providing a hyperlink in the task delivered to the assignee.

8. A computer-implemented method according to claim 7 wherein the hyperlink enables the assignee to do at least one of the following: complete the assigned task; edit the assigned task; accept the assigned task; or decline the assigned task.

9. A computer-implemented method according to claim 1 wherein assigning a task to one or more assignees by specifying an identity designator for each assignee further includes:
determining that there are at least two assignees specified for the assigned task;
creating a single task event assigned to the at least two assignees for the assigned task; and
providing the at least two assignees with the ability to modify the single task event.

10. A computer-implemented method according to claim 1 wherein assigning a task to one or more assignees by specifying an identity designator for each assignee further includes:
determining that there are at least two assignees specified for the assigned task;
creating a separate task event for each of the assignees for the assigned task; and
providing each of the assignees with the ability to access and view their respective task event.

11. A computer-implemented method according to claim 1 further including integrating the steps of assigning a task and delivering the assigned task with an email interface, a web browser interface, an instant messaging client interface, or a telephone interface.

12. A computer-implemented method according to claim 1 wherein the identity designator is an email address, a screenname in an instant messaging client, or a telephone number.

13. A computer-implemented method according to claim 1 wherein one or more assignees are granted read access only to the assigned task for informational purposes and are not expected to complete the task.

14. A computer-implemented method according to claim 13 wherein the identity of one or more of the assignees is not disclosed to other assignees.

15. A computer-implemented method according to claim 12 wherein assigning a task to one or more assignees by specifying an identity designator for each assignee further includes identifying each of the respective email addresses by detecting a comma, semicolon, space or the like in between each email address.

16. A computer-implemented method according to claim 11 further including displaying, at an instant messaging client interface, a task tree associated with an identity designator that enables an instant messaging client user to view all tasks assigned to that identity designator.

17. A method for managing tasks according to claim 16 wherein the tasks are displayed in a secondary popup window.

18. A method for managing tasks according to claim 16 wherein the status of the tasks is graphically displayed.

19. A method for managing tasks according to claim 18 wherein a user can define the status of the task.

20. A software system for managing tasks comprising:
a task management engine assigning a task to one or more assignees by specifying an identity designator for each assignee; and
a task handler accepting task data from a task creator and delivering the assigned task to one of the assignees, where the task is received by the assignee without the assignee having to register with any task management system.

21. A software system according to claim 20 wherein the assigned task is a request created by a creator to complete an action, a poll, a yes/no question, a multiple choice question or a single edit box input.

22. A software system according to claim 21 wherein the assigned task further includes providing a two-way flow of information in which the creator interactively monitors and modifies the assigned task after the assignee has received the task through the task management engine.

23. A software system according to claim 22 wherein the task management engine
enables the creator to track the status of the assigned task; and
alerts the creator when the assigned task has been completed.

24. A software system according to claim 20 wherein the task creator send a reminder to one or more task assignees to complete a task in a command sent to the task handler and performed by the task management engine.

25. A software system according to claim 24 wherein the task handler sends a single reminder containing all selected tasks to an assignee receiving a plurality of reminders for a plurality of independent tasks.

26. A software system according to claim 20 wherein the task handler delivers the assigned task to one of the assignees and provides a hyperlink in the task delivered to the assignee.

27. A software system according to claim 26 wherein the hyperlink enables the assignee to do at least one of the following via the task management engine:
complete the assigned task; edit the assigned task; accept the assigned task; or decline the assigned task.

28. A software system according to claim 20 wherein the task management engine assigns a task to one or more assignees, where the task is received by the assignee without the assignee having to register with any task management system, further
determines that there are at least two assignees specified for the assigned task;
creates a single task event assigned to the at least two assignees for the assigned task; and
provides the at least two assignees with the ability to modify the single task event.

29. A software system according to claim 20 wherein the task management engine assigns a task to one or more assignees, where the task is received by the assignee without the assignee having to register with any task management systems, further
determines that there are at least two assignees specified for the assigned task;
creates a separate task event for each of the assignees for the assigned tasks; and
provides each of the assignees with the ability to access and view their respective task event.

30. A software system according to claim 20 wherein the task management engine integrates the steps of assigning a task and delivering the assigned task with an email interface, a web browser interface, an instant messaging client interface, or a telephone interface.

31. A software system according to claim 20 wherein the identity designator is an email address, a screenname in an instant messaging client, or a telephone number.

32. A software system according to claim 20 wherein the task management engine grants one or more assignees read access only to the assigned task for informational purposes who are not expected to complete the task.

33. A software system according to claim 32 wherein the identity of one or more of the assignees is not disclosed to other assignees.

34. A software system according to claim 31 wherein the task management engine assigns a task to one or more assignees by specifying an identity designator for each assignee further includes identifying each of the respective email address by detecting a comma, semicolon, space or the like in between each email address.

35. A system for managing tasks comprising:
means for assigning a task to one or more assignees by specifying an identity designator for each assignee; and
means for accepting task data from a task creator and delivering the assigned task to one of the assignees, where the task is received by the assignee without the assignee having to register with any task management system.
